(19) United States
(12) Patent Application Publication
(10) Pub. No.: US 2008/0315558 A1
(43) Pub. Date: Dec. 25, 2008

(54) Gooseneck trailer attachment assembly and center deck elevation system

(76) Inventor: Anthony John Cesternino, Callaway, VA (US)

Correspondence Address: Anthony J. Cesternino, 597 Five Mile Mt. Road, CALLAWAY, VA, 24067, US

(21) Appl. No.: 11/821,499

(22) Filed: Jun. 25, 2007

(51) Int. Cl. B62D 53/06

(52) U.S. Cl. 280/441.2

(57) ABSTRACT

A detachable gooseneck trailer [12] having a gooseneck [11] and a detachable trailer deck [10] utilizes a trailer attachment assembly [13] to draw the trailer deck [10] toward the gooseneck [11] during attachment. The attachment assembly [13] includes a rotary trailer lift arm [14] powered by an electric motor [45] which attaches itself to the trailer lift pin [16] which will be raised and drawn towards the gooseneck [13] by the rotation movement of the trailer lift arm [14] to a level 1 position shown in FIG. 1 Position 2. Once in position the lock bars [15] in the gooseneck [13] powered by an air cylinder [16] and a rotating spread screw [17] will enter the trailer lockbox [18] the spread screw [17] will spread the lock bars [15] inside the trailer lockbox [18] and proceed to screw into a threaded block [19] attached to trailer [10] locking the trailer [10] to the gooseneck [13].

When a different height is required for the trailer [10] the gooseneck lock bars [15] are disengaged and the elevator rods [20] in both gooseneck [13] and tandem section [23] will be powered by an electric motor [21] raising the elevator blocks [22] to the new desired height. Once the trailer [10] is at the next height Position 3, FIG. 1 both goosenecks [13] and tandem [23] lock bars systems [15] will relock trailer [10] to both gooseneck [13] and tandem [23].

When Position 4, FIG. 1 is required, the gooseneck [13] lock bar system [15] will disengage and the elevation screw [20] in gooseneck [13] will raise the front part of the trailer [10] to Position 4, FIG. 1 while the airbag system [24] in tandem [23] will raise the entire rear deck [23] allowing the I-beam brace system [25] to raise up to support rear tandem deck [23].

### TECHNICAL FIELD

This invention relates to trailers and every more particularly to trailers with detachable goosenecks, permitting the trailer to detach and attach then raise center and rear deck to multiple heights.

### BACKGROUND

This invention relates to a truck-trailer gooseneck and deck elevation system, particularly for inter-connection of a lowboy trailer that can then be converted by elevators to different levels to form different conventional trailers. Once connected to a ground bearing conventional type lowboy trailer there is no background of the lowboys main and rear decks being elevated to form other conventional type trailers for highway transport.

### SUMMARY OF THE INVENTION

Accordingly this invention is directed to improve attachment and detachment problems caused by alignment of gooseneck to trailer and once attached have the ability to convert to other conventional style trailers allowing the user access to multiple trailer selections depending on need.

### BRIEF DESCRIPTION OF THE DRAWINGS

FIG. 1 is a side view of a detachable gooseneck trailer illustrating 4 positions the center and rear deck can be adjusted to.

FIG. 2 is a three dimensional view of the outer frame for elevator and lock assembly in gooseneck.

FIG. 3 is a three dimensional view of riser screws, treaded blocks, lift and lock arm and lockbox in gooseneck, and trailer lift pin with collar and lockbox in trailer.

FIG. 4 is a three dimensional view of electric motors that drive riser screws and lift and lock arm.

FIG. 5 and FIG. 6 are three dimensional views of rear deck of trailer illustrating rear deck raised and lowered by air system in relation to riser screw, threaded block and lock box assembly.

FIG. 7 is a three dimensional view of I-beam in a rear deck of trailer in raised and lowered position in relation to tandem beams.

FIG. 8 is a three dimensional cross section view of lock bar and treaded screw in relation to the treaded block in gooseneck and treaded block in trailer by which after lock bars enter trailer lockbox treaded box then spreads lock bars in lockbox to lock.

FIG. 9 is a three dimensional view of lockbox assembly in relation to gooseneck and trailer.

FIG. 10 is a side view of multi-positions available to drop trailer along with the bottom view of trailers landing gear device embedded in frame of lowboy trailer.

### DETAILED DESCRIPTION

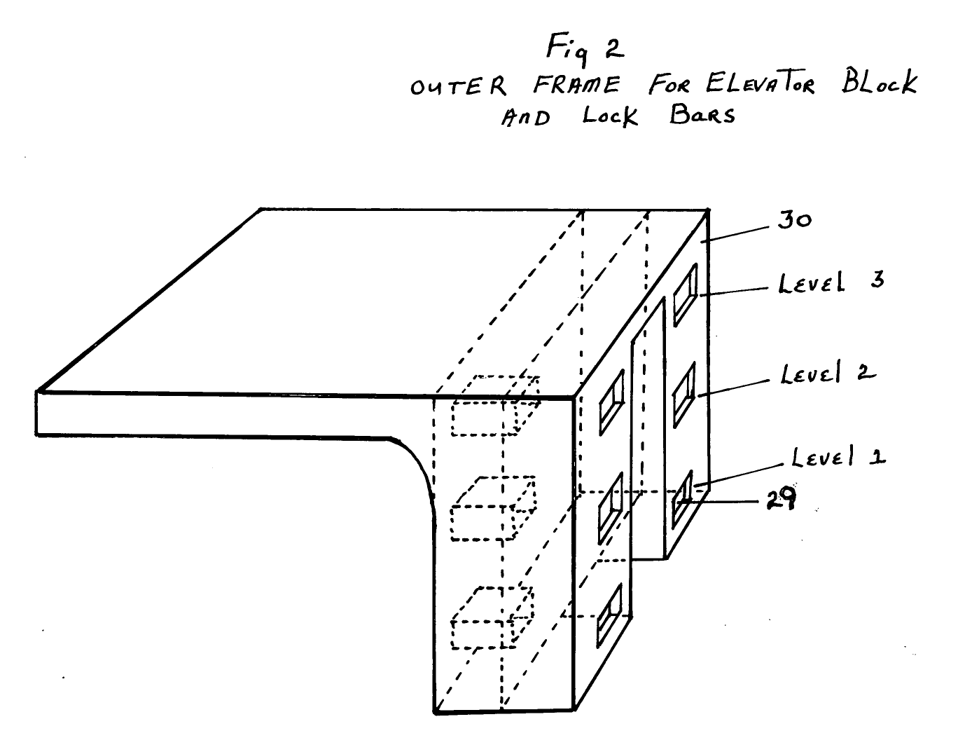

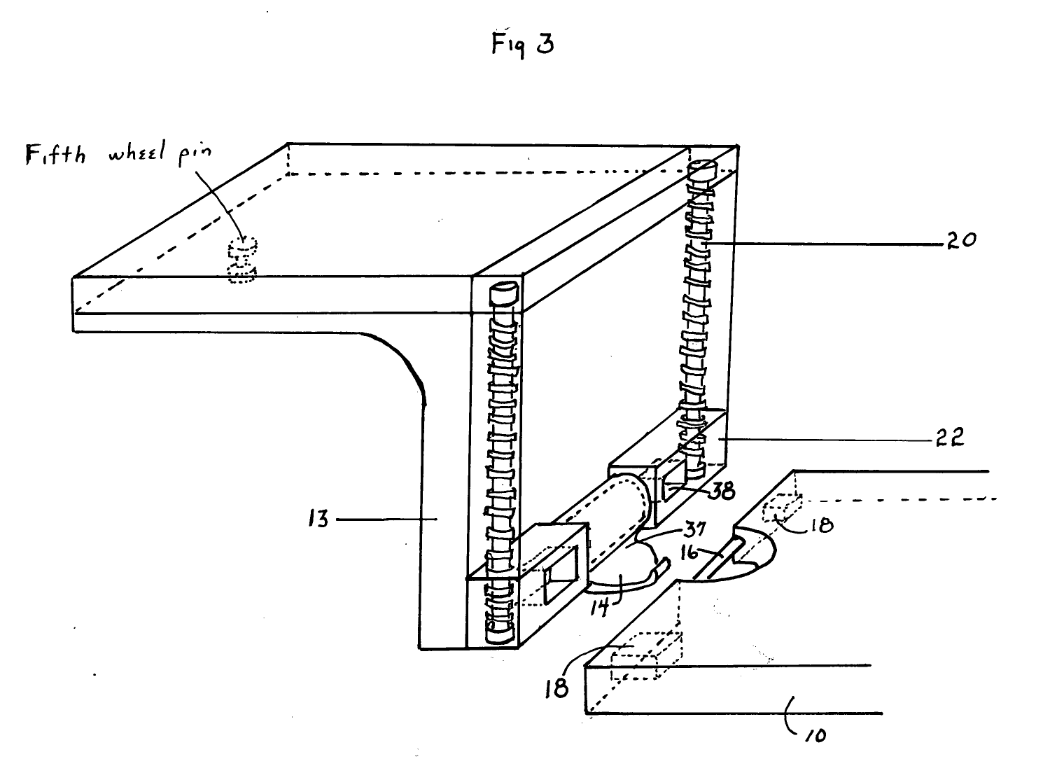

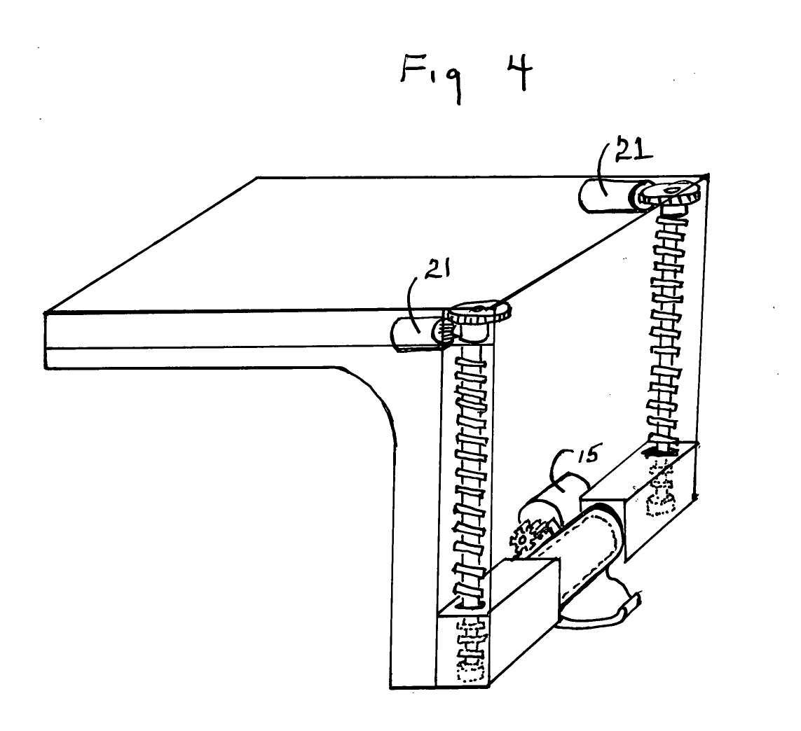

Referring to FIG. 2, the goosenecks outer framing [30] shows predetermined height adjustment holes [24] in which the lock bar assembly [15, 17] slide through. This also houses riser blocks [22] riser screws [20] and a trailer lift arm [14] and the electric motors that power them [21]. Referring to FIG. 3 shows the relationship of the elevation and trailer lift arm housed in the outer gooseneck frame FIG. 2. Referring to FIG. 4 shows the relationship of the electric power units in the gooseneck.

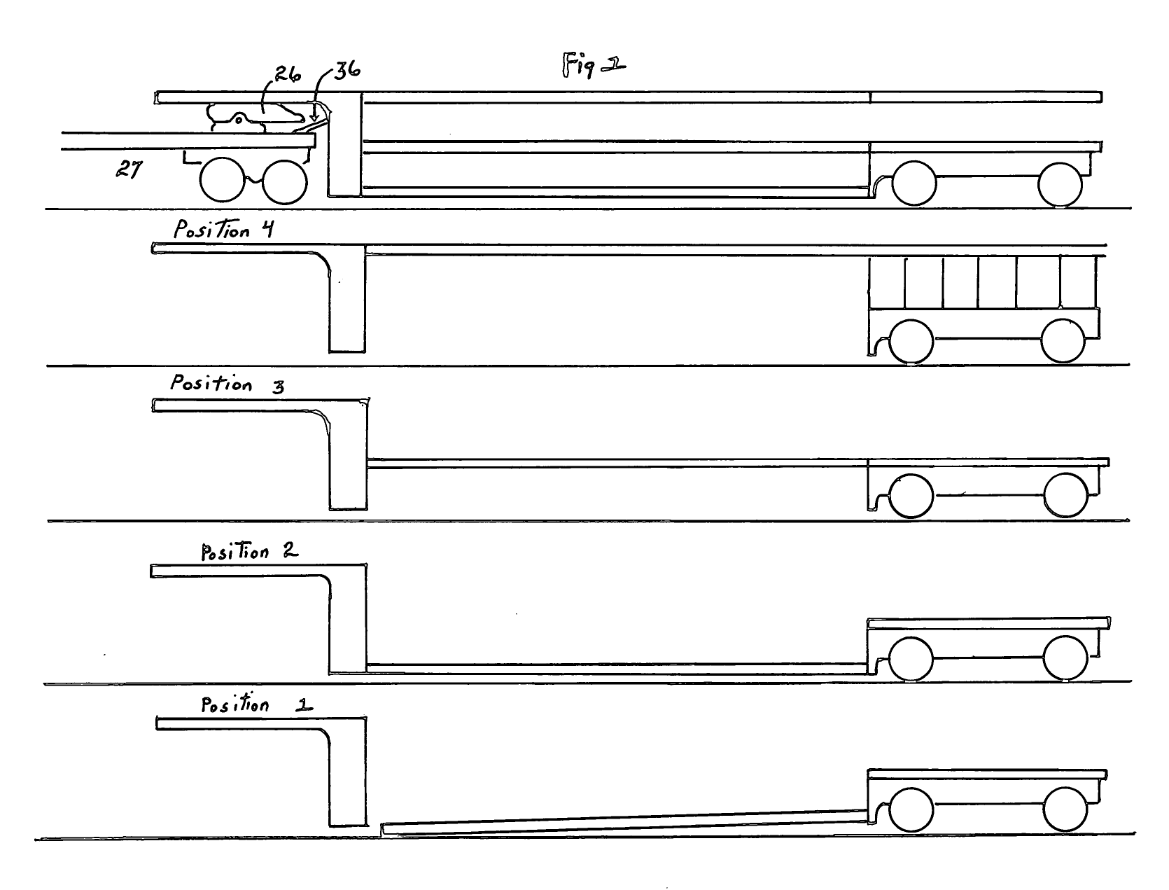

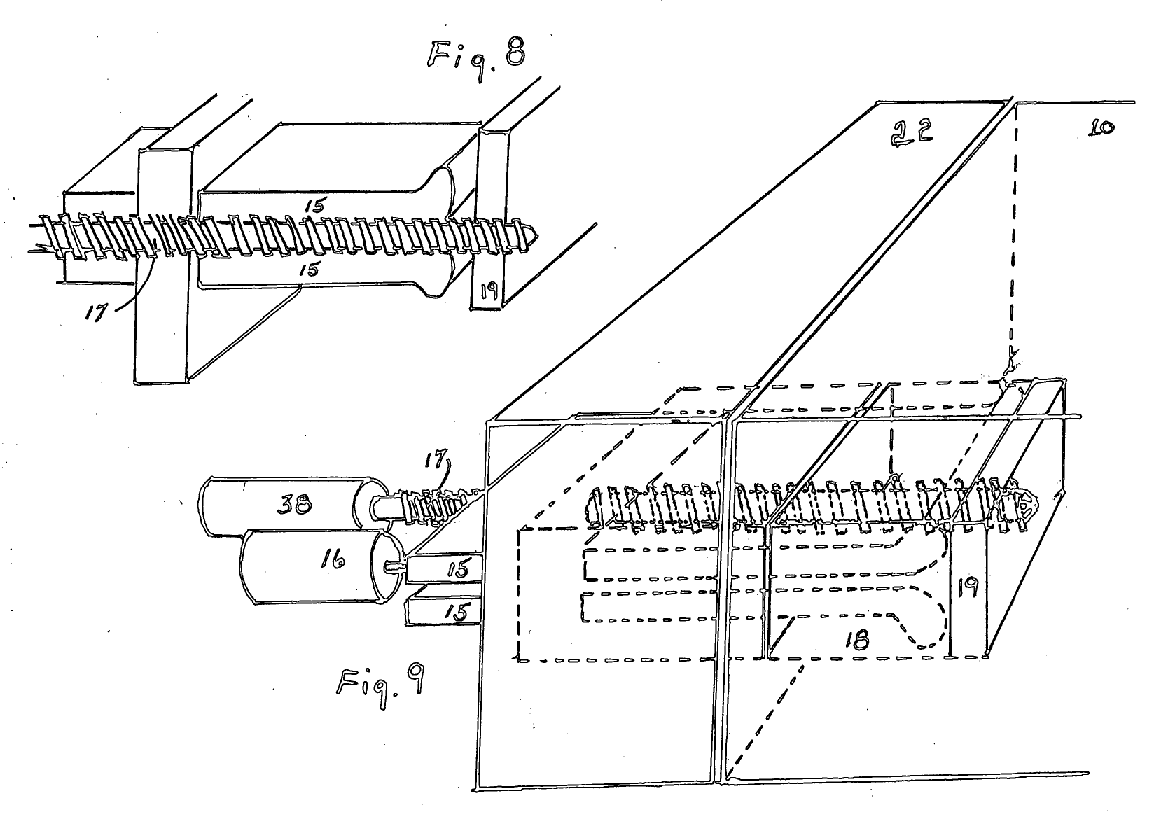

Referring to FIG. 2, 3, 4, once the detached trailer [10] is loaded, the power unit tractor [27] with gooseneck [13] which is locked in a pivotal 5^{th} wheel [26] is backed into the ground bearing trailer [10]. Once gooseneck [13] which is raised by tractor [27] support arm [36] FIG. 1 touches dropped trailer [10] the trailer lift arm [14] which is preset to face down before backing is now activated by an electric motor [45] which rotates trailer lift arm [14] which at some degree of rotation will make contact under trailer lift pin [16] eventually lifting trailer [10] as lift arm [14] rotates upward lilting trailer [10]. Rotation wills then drawer both gooseneck [13] and trailer [10] together as lift pin arm [14] rotates further. Approximately 180 degrees from starting position down, now being straight up and locking trailer lift pin [16] in lock pocket [37] FIG. 3 close to rotating axis of lift pin arm [14]. At this time automatically aligns with lock box [18] in trailer [10] slide holes in treaded block [22] and predetermined height adjustment holes [29] in gooseneck outer frame [30] allowing lock bars [15] housing gooseneck outer frame FIG. 2 to be activated by air cylinder [16] FIG. 9 to slide through treaded riser block slot [38] FIG. 3 and predetermined height adjustment holes [29] FIG. 2 then continue into trailer [10] lockbox [18]. Referring to FIG. 8 a treaded rod [17] will then spread the two lock bars [15] in the precast lock box [18] in trailer [10] then continue into a treaded block [19] drawing and locking trailer [10] to gooseneck [13]. Referring to FIG. 1 now in position 2 tractor and trailer are ready for transport as lowboy.

From position 2 FIG. 1 to position 3 FIG. 1 unlock lock bars [15] in gooseneck [13] engage electric motor [21] for elevator screws [20] to raise elevator blocks [22] in gooseneck [13] to second level in outer frame [30] FIG. 2 of gooseneck [13]. Once lined up engage lock bars [15] to lock: simultaneously engaging electric motor [21] turning elevator screws [20] in tandem section [23] of FIG. 6 to top position. Now in position 3 FIG. 1 tractor and trailer are now ready for transport as drop deck.

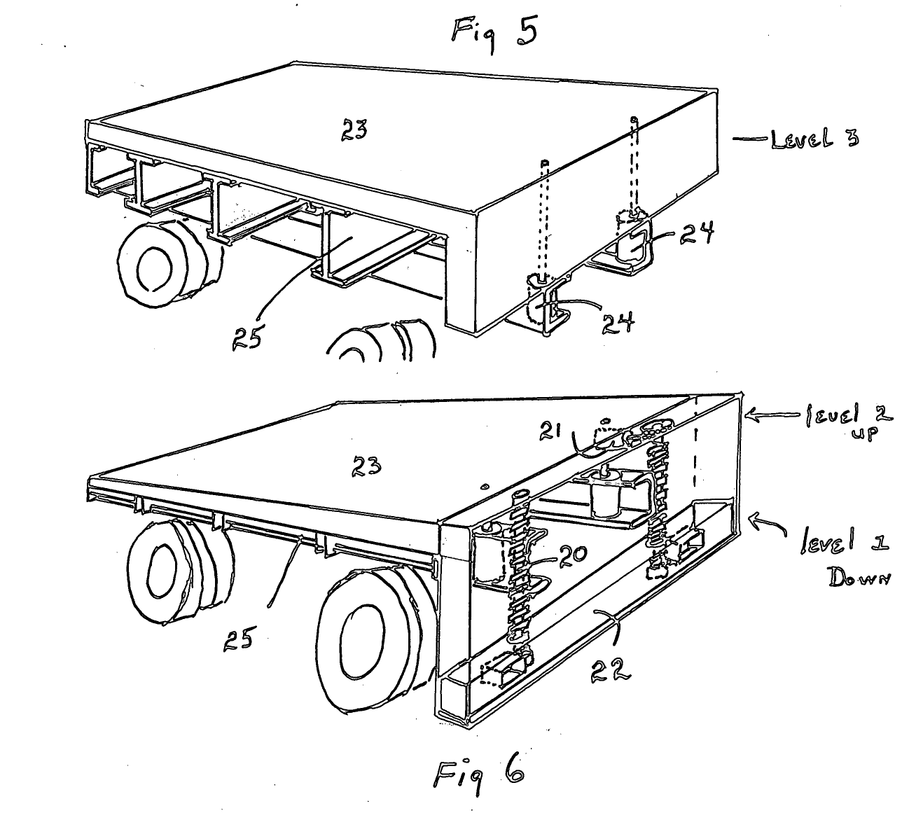

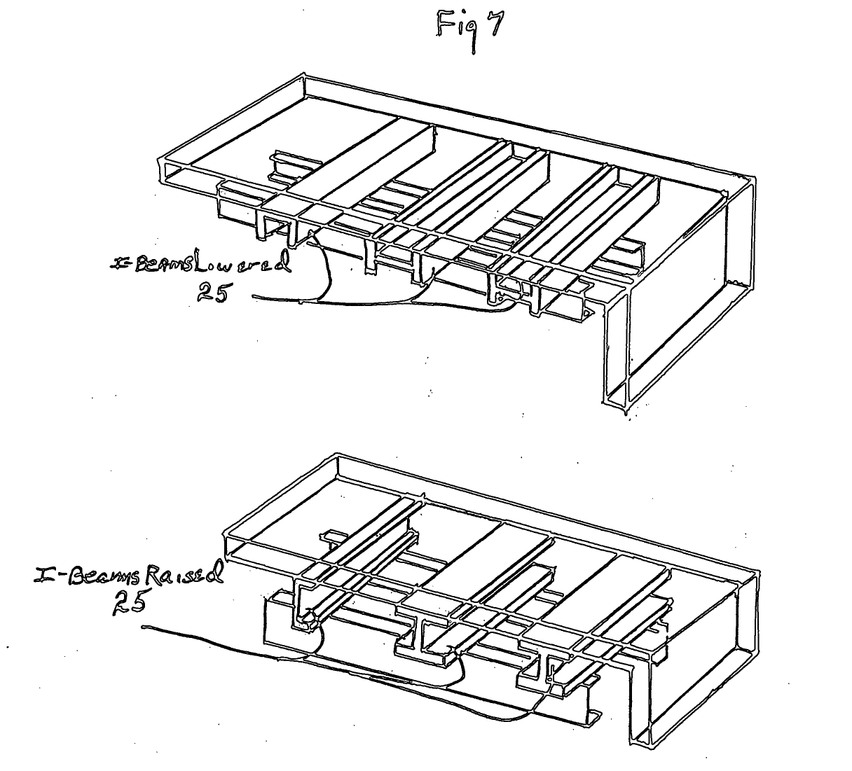

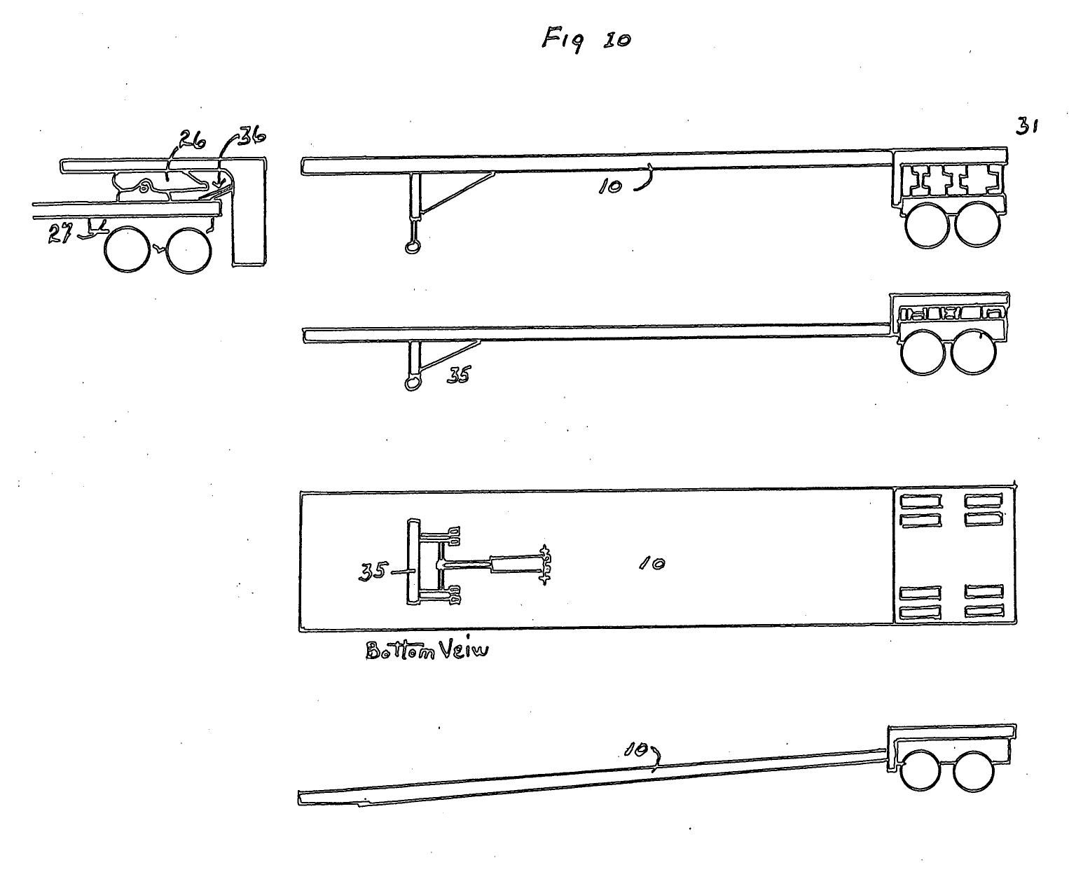

From position 3 FIG. 1 to position 4 FIG. 1 unlock lock bars [15] in gooseneck [13] engage electric motor [21] for elevator screw [20] to raise elevator block [22] in gooseneck [13]: simultaneously engaging elevator for rear deck [24] when height in gooseneck [13] reaches level 3 in outer frame [30] of gooseneck [13] engage lock bars [15]. When rear deck [23] is raised to level 3 FIG. 5 the folding I-beam supporters [25] FIG. 5, FIG. 6, FIG. 7 will engage and lock by spring air arm not shown drawing deck to frame. Referring to FIG. 10 position 3, 4 landing support [35] can be used to drop trailer [10] for loading or leaving. To release trailer [10] in position 3, 4 FIG. 10 once landing system [35] is engaged, disengage gooseneck [13] lock bar system [15] FIG. 8, 9 and trailer lift arm [14] FIG. 3 is then rotated down releasing trailer lift arm pin [16] FIG. 3 releasing trailer [10] from gooseneck [13] leaving trailer lift arm [14] and trailer lift pin FIG. 3 in position to reattach with no adjustments.

What is claimed is:

1. A detachable gooseneck trailer that once attached to gooseneck can adjust to additional height positions, transforming one piece of equipment a lowboy trailer to a drop deck trailer or a flatbed trailer.

2. The attach/detach and lift and lock mechanisms in gooseneck and lift and lock mechanisms in tandem section of trailer, according to claim 1 comprising of:
Riser screws, threaded blocks, rotating lift arm, lock bar assembly in gooseneck part.
Riser screws, threaded blocks, lock bar assembly and an adjustable I-beam system raised and lowered by an air system to raise and lower the rear deck in tandem.

3. The new rotating attach/detach lift and lock mechanism in gooseneck will eliminate alignment problems when attaching or detaching trailer at any height.

4. The trailer can now be dropped as a ground bearing trailer or one supported by retractable landing legs in different height positions.
